(19) United States
(12) Patent Application Publication
(10) Pub. No.: US 2024/0187375 A1
(43) Pub. Date: Jun. 6, 2024

(54) DETECTION AND BLOCKING SYSTEM AND METHOD THROUGH MULTI-CONTAINER-BASED ENCRYPTED PACKET DECRYPTION

(71) Applicant: WINS Co., Ltd., Seongnam-si (KR)

(72) Inventor: Gu Min NAM, Anyang-si, Gyeonggi-do (KR)

(21) Appl. No.: 18/352,192

(22) Filed: Jul. 13, 2023

(30) Foreign Application Priority Data
Dec. 6, 2022 (KR) 10-2022-0168348

(51) Int. Cl. H04L 9/40

(52) U.S. Cl. CPC H04L 63/0236; H04L 63/0485

(57) ABSTRACT

A detection and blocking system through multi-container-based encrypted packet decryption according to an embodiment of the disclosure includes a session management unit configured to generate a session based on a received encrypted packet; a session distribution unit configured to determine a container to decrypt a session packet received from the session management unit to distribute the session packet; a packet processing unit configured to distribute and transmit the distributed session packet to each corresponding container; a plurality of containers configured to decrypt the session packet received from the packet processing unit; and a blocking unit configured to perform pattern inspection on the decrypted packet and generate a detection event and a blocking event according to an inspection result.

### CROSS-REFERENCE TO RELATED APPLICATION(S)

This application is based on and claims priority under 35 U.S.C. 119 to Korean Patent Application No. 10-2022-0168348, filed on Dec. 6, 2022, in the Korean Intellectual Property Office, the disclosure of which is herein incorporated by reference in its entirety.

### BACKGROUND OF THE INVENTION

### Field of the Invention

The present disclosure relates to a detection and blocking system and method through multi-container-based encrypted packet decryption.

### Description of the Prior Art

A deep packet inspection (DPI)-based security system inspects a malicious code pattern in the payload of a received packet to determine whether traffic is malicious. To this end, the payload of the collected packets is required to be unencrypted plain text, but the proportion of encrypted traffic using secure sockets layer (SSL) in Internet traffic is increasing, and a malicious code uses SSL encrypted communication to bypass a security system. In order to detect the malicious code based on DPI with respect to the encrypted traffic, the encrypted traffic is required to first be decrypted and converted into plain text traffic.

To decrypt the encrypted traffic, the security system is required to perform the role of a proxy between a client and a server and to separate a session between the client and the server into two sessions: one between the client and the security system and the other between the security system and the server, which results in a performance decrease of nearly 10 times compared to plain text traffic processing.

Therefore, there is a need for a technique capable of minimizing a performance decrease due to decryption processing by decrypting encrypted traffic at high speed and detecting and blocking malicious codes in encrypted packets at high speed.

### PRIOR ART LITERATURE

### Patent Literature

(Patent Document 1) KR 10-1653956 B1

### SUMMARY OF THE INVENTION

A problem to be solved by the present disclosure is to provide a detection and blocking system and method through multi-container-based encrypted packet decryption, which may decrypt encrypted traffic at high speed to minimize a performance decrease due to decryption processing, and detect and block malicious codes in encrypted packets at high speed.

A DPI-based security system is capable of pattern-based detection only for plain text traffic. Since detection cannot be performed on encrypted traffic such as SSL, transport layer security (TLS), and hypertext transfer protocol secure (HTTPS), detection is performed by decrypting encrypted traffic through a forward proxy or reverse proxy method. To this end, a kernel network stack-based SSL proxy engine of a host is used to perform a decryption function. However, since the kernel network stack-based SSL proxy engine shares kernel resources, it is difficult to achieve performance improvement even if the SSL proxy engine is multiplexed.

The present disclosure has been made in order to solve these problems and an aspect of the present disclosure is to provide a detection and blocking system and method through multi-container-based encrypted packet decryption, which may distribute computing resources in units of containers by configuring multiple containers based on a user space network stack and mounting an SSL proxy engine on the containers, and may distribute traffic through a virtual switch and transmit the distributed traffic to the containers, thereby achieving performance improvements.

In accordance with an aspect of the present disclosure, there is provided a detection and blocking method through multi-container-based encrypted packet decryption, the method including: (A) by a session management unit, generating a session based on a received encrypted packet; (B) by a session distribution unit, determining a container to decrypt a session packet received from the session management unit and distributing the session packet; (C) by a packet processing unit, distributing and transmitting the distributed session packet to each corresponding container; (D) by each of the plurality of containers, decrypting the session packet received from the packet processing unit; and (E) by a blocking unit, performing pattern inspection on the decrypted packet and generating a detection event and a blocking event according to an inspection result.

In the detection and blocking method through multi-container-based encrypted packet decryption according to an embodiment of the disclosure, the blocking unit may include a pattern inspection unit configured to perform pattern inspection on the decrypted packet and a detection and blocking unit configured to generate a detection event and a blocking event according to an inspection result of the pattern inspection unit, and the (E) performing of the pattern inspection may include, by the detection and blocking unit, generating a detection event or a blocking event according to an inspection result of the decrypted packet to request the session management unit to block a corresponding session.

In addition, in the detection and blocking method through multi-container-based encrypted packet decryption according to an embodiment of the disclosure, the packet processing unit may include a virtual switch, and the virtual switch may be a switch to which a data plane acceleration technology is applied, provide a logical interface to each of the plurality of containers, transmit an encrypted session packet received from the session distribution unit to the corresponding container, and transmit the decrypted packets received from the containers to the pattern inspection unit.

In addition, in the detection and blocking method through multi-container-based encrypted packet decryption according to an embodiment of the disclosure, each of the plurality of containers may use a user space network stack (UNS) technology to avoid packet processing delay due to sharing of a kernel network stack between the containers, receive an encrypted session packet through the interface provided by the virtual switch, perform a decryption operation, and then transmit the decrypted session packet to the pattern inspection unit through the interface provided by the virtual switch.

In addition, in the detection and blocking method through multi-container-based encrypted packet decryption according to an embodiment of the disclosure, the pattern inspection unit may perform pattern inspection on the decrypted session packet according to a predetermined policy, and transmit an action set in the policy to the detection and blocking unit along with a session key value when the corresponding session packet is a session packet to be detected.

In addition, in the detection and blocking method through multi-container-based encrypted packet decryption according to an embodiment of the disclosure, the detection and blocking unit may generate a detection or blocking event as needed, and transmit, in case of blocking, the session key value and action received from the pattern inspection unit to the session management unit to request blocking of traffic of the session.

In addition, the detection and blocking method through multi-container-based encrypted packet decryption according to an embodiment may further include, by a container management unit, determining the number of containers according to system resources; and by the virtual switch, generating the same number of virtual interfaces as the number of containers by configuring an interface for processing a session packet and an interface for processing a decrypted packet as a pair based on the number of containers, each container being connected to the virtual interface composed of the pair.

In addition, in the detection and blocking method through multi-container-based encrypted packet decryption according to an embodiment, a decryption performing unit included in each of the plurality of containers may perform decryption on the received packet by generating two sessions, a client-side session and a server-side session, in a proxy method, and return a decrypted packet generated after performing decryption and a session packet corresponding to the two sessions to the virtual switch, and the two session packets may be output to an output interface based on routing through the virtual switch and the decrypted packet may be transmitted to the pattern inspection unit through the virtual switch.

In accordance with another aspect of the present disclosure, there is provided a detection and blocking system through multi-container-based encrypted packet decryption, including: a session management unit configured to generate a session based on a received encrypted packet; a session distribution unit configured to determine a container to decrypt a session packet received from the session management unit to distribute the session packet; a packet processing unit configured to distribute and transmit the distributed session packet to each corresponding container; a plurality of containers configured to decrypt the session packet received from the packet processing unit; and a blocking unit configured to perform pattern inspection on the decrypted packet and generate a detection event and a blocking event according to an inspection result.

In the detection and blocking system through multi-container-based encrypted packet decryption according to an embodiment of the disclosure, the blocking unit may include a pattern inspection unit configured to perform pattern inspection on the decrypted packet and a detection and blocking unit configured to generate a detection event and a blocking event according to an inspection result of the pattern inspection unit, and the detection and blocking unit may generate the detection event or the blocking event according to the inspection result of the decrypted packet to request the session management unit to block the corresponding session.

In addition, in the detection and blocking system through multi-container-based encrypted packet decryption according to an embodiment of the disclosure, the packet processing unit may include a virtual switch, and the virtual switch may be a switch to which a data plane acceleration technology is applied, provide a logical interface to each of the plurality of containers, transmit an encrypted session packet received from the session distribution unit to the corresponding container, and transmit the decrypted packets received from the containers to the pattern inspection unit.

In addition, in the detection and blocking system through multi-container-based encrypted packet decryption according to an embodiment of the disclosure, each of the plurality of containers may use a user space network stack (UNS) technology to avoid packet processing delay due to sharing of a kernel network stack between the containers, receive an encrypted session packet through the interface provided by the virtual switch, perform a decryption operation, and then transmit the decrypted session packet to the pattern inspection unit through the interface provided by the virtual switch.

In addition, in the detection and blocking system through multi-container-based encrypted packet decryption according to an embodiment of the disclosure, the pattern inspection unit may perform pattern inspection on the decrypted session packet according to a predetermined policy, and transmit an action set in the policy to the detection and blocking unit along with a session key value when the corresponding session packet is a session packet to be detected.

In addition, in the detection and blocking system through multi-container-based encrypted packet decryption according to an embodiment of the disclosure, the detection and blocking unit may generate a detection or blocking event as needed, and transmit, in case of blocking, the session key value and action received from the pattern inspection unit to the session management unit to request blocking of traffic of the session.

In addition, the detection and blocking system through multi-container-based encrypted packet decryption according to an embodiment of the disclosure may further include a container management unit configured to determine the number of containers according to system resources, wherein the virtual switch may generate the same number of virtual interfaces as the number of containers by configuring an interface for processing a session packet and an interface for processing a decrypted packet as a pair based on the number of containers, and each container may be connected to the virtual interface composed of the pair.

In addition, in the detection and blocking system through multi-container-based encrypted packet decryption according to an embodiment of the disclosure, each of the plurality of containers may include a decryption performing unit, the decryption performing unit may perform decryption on the received packet by generating two sessions, a client-side session and a server-side session, in a proxy method, and return a decrypted packet generated after performing decryption and a session packet corresponding to the two sessions to the virtual switch, and the two session packets may be output to an output interface based on routing through the virtual switch and the decrypted packet may be transmitted to the pattern inspection unit through the virtual switch.

According to the detection and blocking system and method through multi-container-based encrypted packet decryption according to an embodiment of the disclosure, it is possible to decrypt encrypted traffic at a high speed to minimize a performance decrease due to the decryption processing, and to detect and block malicious codes in an encrypted packet at high speed.

According to the detection and blocking system and method through multi-container-based encrypted packet decryption according to an embodiment of the disclosure, the decryption processing performance may be improved by classifying encrypted traffic for each session and distributing the classified sessions to multiple containers to perform decryption.

The detection and blocking system and method through multi-container-based encrypted packet decryption according to an embodiment of the disclosure is a method for minimizing a performance decrease due to decryption processing, and may process decryption operations in parallel through multiple containers, thereby improving the decryption performance and malicious code detection and blocking performance.

According to the detection and blocking system and method through multi-container-based encrypted packet decryption according to an embodiment of the disclosure, it is possible to improve the decryption performance and malicious code detection and blocking performance by transmitting encrypted traffic to multiple containers at high speed in a zero-copy method and receiving decrypted traffic from the multiple containers.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a conceptual diagram illustrating a detection and blocking system through multi-container-based encrypted packet decryption according to an embodiment of the disclosure.

FIG. 2 is a block diagram illustrating a detection and blocking system through multi-container-based encrypted packet decryption according to an embodiment of the disclosure.

FIG. 3 is a flowchart illustrating a detection and blocking method through multi-container-based encrypted packet decryption according to an embodiment of the disclosure.

### DETAILED DESCRIPTION OF THE EXEMPLARY EMBODIMENTS

Hereinafter, the embodiments disclosed in this specification will be described in detail with reference to the accompanying drawings, but the same or similar components are given the same reference numerals regardless of reference numerals, and redundant descriptions thereof will be omitted. Since the suffixes “module” and “unit” for components used in the following description are given and interchanged for easiness in making the present disclosure, they do not have distinct meanings or functions. Hereinafter, the term “unit” or “module” refer to a software component, or a hardware component such as FPGA or ASIC, and performs a certain function. However, the “unit” or “module are not limited to software or hardware. The “unit” or “module” may be configured in an addressable storage medium and may be configured to be executed by one or more processors. Hence, the “unit” or “module” include elements such as software elements, object-oriented software elements, class elements, and task elements, and processes, functions, attributes, procedures, subroutines, segments of program codes, drivers, firmware, micro-codes, circuits, data, databases, data structures, tables, arrays, and variables. The functions provided in the elements, the units, and the modules may be combined into a fewer number of elements, units, and modules, or may be divided into a larger number of elements, units, and modules.

In addition, in describing the embodiments disclosed in the present specification, detailed descriptions of related well-known technologies are omitted when it is determined that the gist of the embodiments disclosed in the present specification may be obscured. In addition, the accompanying drawings are only for easy understanding of the embodiments disclosed in the present specification, and the technical spirit disclosed in the specification is not limited by the accompanying drawings, and all modifications included in the spirit and technical scope of the present disclosure should be understood to include equivalents or substitutes.

Hereinafter, a detection and blocking system through multi-container-based encrypted packet decryption according to an embodiment of the disclosure will be described with reference to the accompanying drawings.

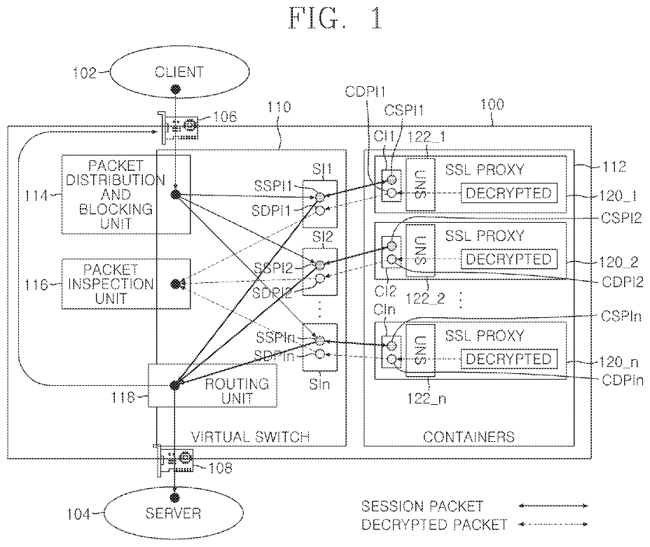

FIG. 1 is a conceptual diagram illustrating a detection and blocking system 100 through multi-container-based encrypted packet decryption according to an embodiment of the disclosure.

The detection and blocking system 100 through multi-container-based encrypted packet decryption according to an embodiment of the disclosure shown in FIG. 1 is a system for performing detection and blocking by decrypting SSL or TLS traffic transmitted between a client 102 and a server 104, that is, encrypted packets at high speed, and may include a packet distribution and blocking unit 114, a virtual switch 110 as a packet processing unit, a container-based decryption processing unit 112, a packet inspection unit 116, and a routing unit 118.

The packet distribution and blocking unit 114 may generate a session based on a received encrypted packet, determine a container to decrypt a session packet to distribute the session packet, and block traffic of the session if necessary.

The virtual switch 110 may distribute and transmit the session packets distributed from the packet distribution and blocking unit 114 to each corresponding container at high speed, and receive the processed result.

The decryption processing unit 112 may be composed of one or more containers for decrypting session packets received from the virtual switch 110. In an embodiment of the disclosure, the decryption processing unit 112 may include a plurality of containers 120_1 to 120_n. The decryption processing unit 112 may decrypt the session packets received from the virtual switch 110 in parallel on a container basis.

Meanwhile, each of the plurality of containers 120_1 to 120_n may use a UNS (122_1 to 122_n) technology in order to avoid packet processing delay due to sharing of a kernel network stack between the containers.

The packet inspection unit 116 may perform pattern inspection on a decrypted session packet according to a predetermined policy, generate a detection or blocking event as necessary, and in case of blocking, transmit a corresponding session key value and action to the packet distribution and blocking unit 114 to request blocking of traffic of the corresponding session.

The routing unit 118 may transmit the session packets received from the virtual switch 110 to the client 102 or server 104 through network interface cards 106 and 108.

The virtual switch 110 is a switch to which a data plane acceleration technology is applied, and may provide logical interfaces CI1 to CIn to each of the plurality of containers 120_1 to 120_n.

In addition, the virtual switch 110 may generate the same number of virtual interfaces SI1 to SIn as the number of the plurality of containers 120_1 to 120_n by configuring interfaces SSPI1 to SSPIn for processing session packets and interfaces SDPI1 to SDPIn for processing decrypted packets as a pair ({SSPI1, SDPI1} . . . {SSPIn, SDPIn}) based on the number of the plurality of containers 120_1 to 120_n.

The logical interfaces CI1 to Cn of the plurality of containers 120_1 to 120_n may include interfaces CSPI1 to CSPIn for processing session packets and interfaces CDPI1 to CDPIn for processing decryption packets as a pair ({CSPI1, CDPI1} . . . {CSPIn, CDPIn}).

Each of the interfaces CSPI1 to CSPIn for processing the session packets of the logical interfaces CI1 to Cn of the plurality of containers 120_1 to 120_n may be connected to each of the interfaces SSPI1 to SSPIn for processing the session packets of the virtual interfaces SI1 to SIn of the virtual switch 110.

Each of the interfaces CDPI1 to CDPIn for processing the decrypted packets of the logical interfaces CI1 to CIn of the plurality of containers 120_1 to 120_n may be connected to each of the interfaces SDPI1 to SDPIn for processing the decrypted packets of the virtual interfaces SI1 to SIn of the virtual switch 110.

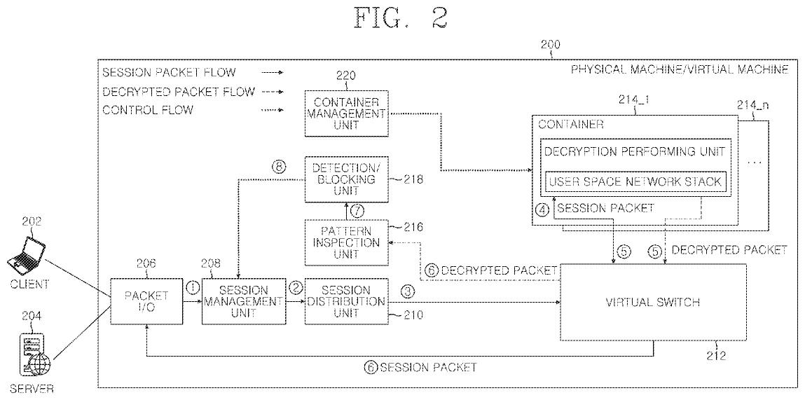

FIG. 2 is a block diagram illustrating a detection and blocking system 200 through multi-container-based encrypted packet decryption according to an embodiment of the disclosure.

The detection and blocking system 200 through multi-container-based encrypted packet decryption according to an embodiment of the disclosure shown in FIG. 2 is a system for performing detection and blocking by decrypting SSL or TLS traffic transmitted between a client 202 and a server 204, that is, encrypted packets at high speed, and may include a packet I/O 206, a session management unit 208, a session distribution unit 210, a virtual switch 212 as a packet processing unit, a plurality of containers 214_1 to 214_n as a decryption processing unit, blocking units 216 and 218, and a container management unit 220.

In the detection and blocking system 200 through multi-container-based encrypted packet decryption according to an embodiment of the disclosure, the blocking units 216 and 218 may include the pattern inspection unit 216 and the detection and blocking unit 218.

The detection and blocking system 200 through multi-container-based encrypted packet decryption according to an embodiment of the disclosure shown in FIG. 2 may be configured as a physical machine or a virtual machine, or configured as a program including computer-readable instructions to be performed by a device including one or more processor and a memory.

The packet I/O 206 may receive SSL or TLS traffic, that is, encrypted packets transmitted between the client 202 and the server 204, or transmit session packets received from the virtual switch 212 to the client 202 or the server 204.

The session management unit 208 may generate a session based on the received encrypted packet. The session management unit 208 may generate sessions classified based on 5 tuples (source IP/Port, destination IP/Port, protocol) of the received packet. In addition, the session management unit 208 may block all packets of the corresponding session when blocking is set for the corresponding session.

The session management unit 208 may manage traffic introduced into the device as a 5-tuples-based session. Session is a method for managing two-section sessions as one session, and uses Min (source IP, destination IP), Min (source port, destination port), Max (source IP, destination IP), Max (source port, destination port), and protocol as key values to distinguish sessions.

The session distribution unit 210 may determine a container to decrypt session packets received from the session management unit 208 and distribute the session packets. The session distribution unit 210 may provide a function of efficiently distributing traffic and transmitting the distributed traffic to a specific container.

The session distribution unit 210 may distribute sessions so that each session is assigned to a container that is processing the least amount of traffic based on the current traffic throughput for each container. Thereafter, all packets of the same session are transmitted to the container determined above.

The virtual switch 212 may distribute and transmit the distributed session packets received from the session distribution unit 210 to the respective containers. The virtual switch 212 is a switch to which a data plane acceleration technology is applied to process packet input/output at high speed, and as described with reference to FIG. 1, and provide a logical interface to the plurality of containers 214_1 to 214_n. The virtual switch 212 may provide a function of transmitting encrypted traffic to the plurality of containers 214_1 to 214_n serving as a decryption processing unit and transmitting decrypted traffic to the pattern inspection unit 216.

The plurality of containers 214_1 to 214_n serving as a decryption processing unit may decrypt the session packets received from the virtual switch 212 in parallel. The plurality of containers 214_1 to 214_n may use a UNS technology in order to avoid packet processing delay due to sharing of a kernel network stack between the plurality of containers 214_1 to 214_n, and receive an encrypted session packet through an interface provided by the virtual switch 212, perform a decryption operation, and then provide the decrypted session packet to the pattern inspection unit 216 through the interface provided by the virtual switch 212.

For high-speed packet processing between the virtual switch 212 and the plurality of containers 214_1 to 214_n, the data plane acceleration technology and the UNS technology may be used. Through the above technologies, packets introduced into a network interface card (NIC) may be transmitted to the decryption performing units of the plurality of containers 214_1 to 214_n in a zero-copy method without passing through the kernel network stack.

As an embodiment, the data plane acceleration technology may include DPDK, ODP, and the like, and the UNS technology may include VPP, f-stack, and mTCP. The data plane acceleration technology and the UNS technology can be applied separately or applied in a combined form. In an embodiment of the disclosure, a case in which they are separately applied will be described.

Regarding the configuration of the virtual interface of the container, the virtual switch 212 may generate the same number of virtual interfaces as the number of containers by configuring an interface for processing session packets and an interface for processing decrypted packets as a pair. Each of the containers 214_1 to 214_n is connected to the virtual interface composed of the pair.

The session packets introduced into the plurality of containers 214_1 to 214_n are transmitted to the decryption performing unit. The decryption performing unit may generate a decrypted packet by performing a forward proxy or reverse proxy function for both client-proxy and proxy-server sections of the session packet, and the decrypted packet is transmitted to the pattern inspection unit 216 via the virtual switch 212 through the interface of the containers 214_1 to 214_n. The forward proxy may include, for example, SSLsplit, SSLproxy, and the like, and the reverse proxy may include, for example, HAProxy, nginx, and the like.

The pattern inspection unit 216 may perform pattern inspection to detect the payload of the decrypted packet based on a pattern. The pattern inspection unit 216 is a DPI-based engine, and may perform pattern inspection on decrypted traffic according to a predetermined policy, and transmit, in case of traffic to be detected, an action set in the policy to the detection and blocking unit 218 along with a key value.

The detection and blocking unit 218 may generate a detection event according to the pattern inspection result of the pattern inspection unit 216 or request the session management unit 208 to block the corresponding session. The detection and blocking unit 218 may generate a detection event in the case of detection and a blocking event in the case of blocking, and transmit the session key value and action received from the pattern inspection unit 216 to the session management unit 208, thereby requesting the session management unit 208 to block traffic of the corresponding session.

The container management unit 220 may determine the number of the plurality of containers 214_1 to 214_n according to manager settings or system resources, and transmit the determined number of the plurality of containers 214_1 to 214_n to the virtual switch 212, so that the virtual switch 212 may generate the same number of interfaces as the number of the plurality of containers 214_1 to 214_n.

The operation of the detection and blocking system 200 through multi-container-based encrypted packet decryption according to an embodiment of the disclosure shown in FIG. 2 will be described in detail below.

\textcircled{1} The packet I/O 206 transmits a packet to the session management unit 208 when the packet is introduced. \textcircled{2} The session management unit 208 generates and manages sessions based on 5 tuples. \textcircled{3} The session distribution unit 210 selects a container to process the packet, and \textcircled{4} transmits the packet and packets corresponding to the session of the packet to the corresponding container among the plurality of containers 214_1 to 214_n through the virtual switch 212 and the UNS.

\textcircled{5} The decryption performing unit mounted in the containers 214_1 to 214_n receives the packet and generates two sessions, a client-side session and a server-side session, in a proxy method to perform decryption. At this time, the generated decrypted packet and each packet corresponding to the two sessions are returned to the virtual switch 212. \textcircled{6} At this time, the two session packets are output to the packet I/O 206 based on routing, and the decrypted packet is transmitted to the pattern inspection unit 216.

\textcircled{7} The pattern inspection unit 216 detects the payload of the decrypted packet based on the pattern and transmits the pattern and detection result to the detection and blocking unit 218. \textcircled{8} The detection and blocking unit 218 generates a detection event according to the detection result or requests the session management unit 208 to block the corresponding session.

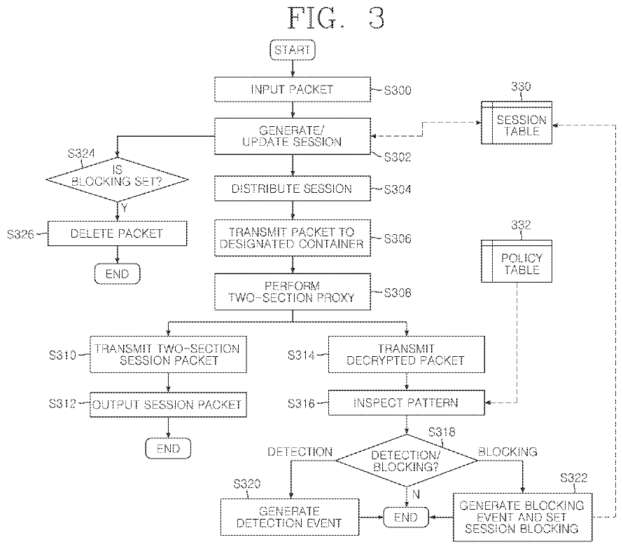

FIG. 3 is a flowchart illustrating a detection and blocking method through multi-container-based encrypted packet decryption according to an embodiment of the disclosure.

Referring to FIGS. 2 and 3, in operation S300, SSL or TLS traffic transmitted between the client 202 and the server 204, that is, an encrypted packet is input through the packet I/O 206.

In operation S302, the session management unit 208 generates or updates a session based on the encrypted packet received from the packet I/O 206, and stores related session information in a session table 330.

Meanwhile, information generated by the detection and blocking system 200 through multi-container-based encrypted packet decryption according to an embodiment of the disclosure is as follows. the session packets received from the virtual switch 212 in parallel. The plurality of containers 214_1 to 214_n may use a UNS technology to avoid packet processing delay due to sharing of a kernel network stack between the plurality of containers 214_1 to 214_n. After receiving the encrypted session packet through the interface provided by the virtual switch 212 and performing a decryption operation, in operation S314, the plurality of containers 214_1 to 214_n may transmit the decrypted session packet to the pattern inspection unit 216 through the interface provided by the virtual switch 212.

In operation S316, the pattern inspection unit 216 performs pattern inspection to detect the payload of the decrypted packet based on a pattern. The pattern inspection unit 216 is a DPI-based engine and may perform pattern inspection on decrypted traffic according to a predetermined policy stored in the policy table 332, and transmit, in case of traffic to be detected, an action set in the policy to the detection and blocking unit 218 along with a key value.

In operation S318, the detection and blocking unit 218 generates a detection event in operation S320 in case of detection according to the pattern inspection result of the pattern inspection unit 216, or generates a blocking event in case of blocking, and sets session blocking of the corresponding session, thereby requesting the session management unit 208 to block the corresponding session in operation S322. In case of blocking, the detection and blocking unit 218 may transmit the session key value and action received from the pattern inspection unit 216 to the session management unit 208 to request blocking of the traffic of the corresponding session.

Meanwhile, in operation S324, the session management unit 208 determines whether blocking is set for the corresponding session, and when blocking is set for the corresponding session, in operation S326, the session management unit 208 deletes all packets of the corresponding session.

In operation S310, the virtual switch 212 transmits session packets for both the client-proxy and proxy-server sections to the packet I/O 206, and in operation S312, the packet I/O 206 outputs the session packets based on routing.

In the detection and blocking systems 100 and 200 through multi-container-based encrypted packet decryption according to an embodiment of the disclosure and the detection and blocking method through multi-container-based encrypted packet decryption according to an embodiment of the disclosure, a container may refer to an isolation technology such as a Linux process or a network, and a session packet is a packet corresponding to a two-section session for performing proxy and may refer to a packet corresponding to a session of a client-decryption performing unit section and a session of a decryption performing unit-server section. The decrypted packet may refer to a decrypted packet generated by the decryption performing unit.

The UNS may refer to a network stack that implements core TCP/IP functions in user space among kernel network stack functions, and data plane development kit (DPDK) and open data plane (ODP) may refer to a data plain acceleration technology.

The above-described present invention can be implemented as a computer-readable code on a medium on which a program is recorded. The computer-readable medium may continuously store programs executable by the computer or temporarily store them for execution or download. In addition, the medium may be various recording means or storage means in the form of a single or combined hardware, and is not limited to a medium directly connected to a certain computer system, and may be distributed on a network. Examples of the medium include magnetic media such as hard disks, floppy disks and magnetic tapes, optical recording media such as CD-ROM and DVD, magneto-optical media such as floptical disks, and ROM, RAM, flash memory, etc., and may be configured to store program instructions. In addition, examples of other media include recording media or storage media managed by an app store that distributes applications, a site that supplies or distributes various other software, and a server. Accordingly, the above detailed description should not be construed as limiting in all respects and should be considered illustrative. The scope of the present disclosure should be determined by reasonable interpretation of the appended claims, and all changes within the equivalent scope of the present disclosure are included in the scope of the present disclosure.

The present disclosure is not limited by the foregoing embodiments and accompanying drawings. It will be clear to those skilled in the art that the components according to the present disclosure can be substituted, modified, and changed without departing from the technical spirit of the present disclosure.

What is claimed is:

1. A method for detection and blocking through multi-container-based encrypted packet decryption, the method comprising:
(A) by a session management unit, generating a session based on a received encrypted packet;
(B) by a session distribution unit, determining a container to decrypt a session packet received from the session management unit and distributing the session packet;
(C) by a packet processing unit, distributing and transmitting the distributed session packet to each corresponding container;
(D) by each of the plurality of containers, decrypting the session packet received from the packet processing unit; and
(E) by a blocking unit, performing pattern inspection on the decrypted packet and generating a detection event and a blocking event according to an inspection result.

2. The method of claim 1, wherein the blocking unit includes a pattern inspection unit configured to perform pattern inspection on the decrypted packet and a detection and blocking unit configured to generate a detection event and a blocking event according to an inspection result of the pattern inspection unit, and
the (E) performing of the pattern inspection includes, by the detection and blocking unit, generating a detection event or a blocking event according to an inspection result of the decrypted packet to request the session management unit to block a corresponding session.

3. The method of claim 2, wherein the packet processing unit includes a virtual switch, and
the virtual switch is a switch to which a data plane acceleration technology is applied, provides a logical interface to each of the plurality of containers, transmits an encrypted session packet received from the session distribution unit to the corresponding container, and transmits the decrypted packets received from the containers to the pattern inspection unit.

4. The method of claim 3, wherein each of the plurality of containers
uses a user space network stack (UNS) technology to avoid packet processing delay due to sharing of a kernel network stack between the containers, and
receives an encrypted session packet through the interface provided by the virtual switch, performs a decryption operation, and then transmits the decrypted session packet to the pattern inspection unit through the interface provided by the virtual switch.

5. The method of claim 2, wherein the pattern inspection unit performs pattern inspection on the decrypted session packet according to a predetermined policy, and transmits an action set in the policy to the detection and blocking unit along with a session key value when the corresponding session packet is a session packet to be detected.

6. The method of claim 5, wherein the detection and blocking unit generates a detection or blocking event as needed, and transmits, in case of blocking, the session key value and action received from the pattern inspection unit to the session management unit to request blocking of traffic of the session.

7. The method of claim 4, further comprising:
by a container management unit, determining the number of containers according to system resources; and
by the virtual switch, generating the same number of virtual interfaces as the number of containers by configuring an interface for processing a session packet and an interface for processing a decrypted packet as a pair based on the number of containers, each container being connected to the virtual interface composed of the pair.

8. The method of claim 3, wherein a decryption performing unit included in each of the plurality of containers performs decryption on the received packet by generating two sessions, a client-side session and a server-side session, in a proxy method, and returns a decrypted packet generated after performing decryption and a session packet corresponding to the two sessions to the virtual switch,
the two session packets are output to an output interface based on routing through the virtual switch, and
the decrypted packet is transmitted to the pattern inspection unit through the virtual switch.

9. A system for detection and blocking through multi-container-based encrypted packet decryption, the system comprising:
a session management unit configured to generate a session based on a received encrypted packet;
a session distribution unit configured to determine a container to decrypt a session packet received from the session management unit to distribute the session packet;
a packet processing unit configured to distribute and transmit the distributed session packet to each corresponding container;
a plurality of containers configured to decrypt the session packet received from the packet processing unit; and
a blocking unit configured to perform pattern inspection on the decrypted packet and generate a detection event and a blocking event according to an inspection result.

10. The system of claim 9, wherein the blocking unit includes a pattern inspection unit configured to perform pattern inspection on the decrypted packet and a detection and blocking unit configured to generate a detection event and a blocking event according to an inspection result of the pattern inspection unit, and
the detection and blocking unit generates the detection event or the blocking event according to the inspection result of the decrypted packet to request the session management unit to block the corresponding session.

11. The system of claim 10, wherein the packet processing unit includes a virtual switch, and
the virtual switch is a switch to which a data plane acceleration technology is applied, provides a logical interface to each of the plurality of containers, transmits an encrypted session packet received from the session distribution unit to the corresponding container, and transmits the decrypted packets received from the containers to the pattern inspection unit.

12. The system of claim 11, wherein each of the plurality of containers
uses a UNS technology to avoid packet processing delay due to sharing of a kernel network stack between the containers, and
receives an encrypted session packet through the interface provided by the virtual switch, performs a decryption operation, and then transmits the decrypted session packet to the pattern inspection unit through the interface provided by the virtual switch.

13. The system of claim 10, wherein the pattern inspection unit performs pattern inspection on the decrypted session packet according to a predetermined policy, and transmits an action set in the policy to the detection and blocking unit along with a session key value when the corresponding session packet is a session packet to be detected.

14. The system of claim 13, wherein the detection and blocking unit generates a detection or blocking event as needed, and transmits, in case of blocking, the session key value and action received from the pattern inspection unit to the session management unit to request blocking of traffic of the session.

15. The system of claim 12, further comprising a container management unit configured to determine the number of containers according to system resources,
wherein the virtual switch generates the same number of virtual interfaces as the number of containers by configuring an interface for processing a session packet and an interface for processing a decrypted packet as a pair based on the number of containers, and
each container is connected to the virtual interface composed of the pair.

16. The system of claim 11, wherein each of the plurality of containers includes a decryption performing unit,
the decryption performing unit performs decryption on the received packet by generating two sessions, a client-side session and a server-side session, in a proxy method, and returns a decrypted packet generated after performing decryption and a session packet corresponding to the two sessions to the virtual switch, and
the two session packets are output to an output interface based on routing through the virtual switch, and the decrypted packet is transmitted to the pattern inspection unit through the virtual switch.
